(19) United States
(12) Patent Application Publication
(10) Pub. No.: US 2024/0326105 A1
(43) Pub. Date: Oct. 3, 2024

(54) DRAIN CLEANING MACHINE

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 18/619,420

(22) Filed: Mar. 28, 2024

(30) Foreign Application Priority Data
Mar. 28, 2023 (CN) 2023103488035

(51) Int. Cl. B08B 9/045; E03C 1/302

(52) U.S. Cl. CPC B08B 9/045; E03C 1/302

(57) ABSTRACT

A drain cleaning machine including a machine body with a drive assembly, rotary drum having a flexible shaft wound therein, and lead frame guiding the flexible shaft to advance and retract; the lead frame includes an inner base, outer cylinder, and locking structures; the lead frame includes an inner base, an outer cylinder, and locking structures; each locking structure includes a slider, a rotary member, and an elastic member; the outer cylinder is provided with abutting sections. The drain cleaning machine reasonably simplifies the structure of the lead frame by reasonably setting the specific structures of the lead frame and the locking structures, where the slider may drive the rotary member to move towards or away from the flexible shaft via forward/reverse rotation of the outer cylinder, which facilitates user operation.

### FIELD

The present disclosure relates to the technical field of power tools, and more particularly relates to a drain cleaning machine.

### BACKGROUND

In daily life, drain pipes in kitchens, bathrooms, and flush toilets are susceptible to being clogged, causing trouble to people. A drain cleaning machine is a tool for cleaning and unclogging a sewer pipe via a flexible steel wire. There are two different types of drain cleaning machines by actuation manners: hand-powered and electrically-driven. Existing electric drain cleaning machines generally comprise a flexile steel wire, a rotary drum for accommodating the flexible steel wire, and an electric motor for driving the rotary drum to rotate, where when the electric motor drives the rotary drum to rotate forwardly, the flexible steel wire wound within the rotary drum advances into the sewer pipe, and when the electric motor drives the rotary drum to rotate reversely, the flexible steel wire retracts and is rewound into the rotary drum. To prevent the flexible steel wire from retracting upon encountering an obstruction during pipe unclogging, a locking mechanism for locking the flexible steel wire is further provided for the drain cleaning machine.

The invention patent publication No. CN 106854890B discloses a flexible-shaft locking mechanism for a drain cleaning machine and such a drain cleaning machine, in which the flexible-shaft locking mechanism adopts a resilient locking piece and a locking ring, the resilient locking piece comprising a connector end and a locking end, the locking ring comprising an outer ring and an inner ring; the outer ring, when rotating, drives the inner ring to rotate in a hollow part, so that a locking sidewall of the inner ring and the locking end are fitted for pressing or releasing the resilient locking piece to thereby realize locking or unlocking of the flexible shaft. In addition, the drain cleaning machine is further provided with a flexible-shaft telescoping control mechanism, the flexible-shaft telescoping control mechanism comprising a fixed bearing housing, a movable bearing house, and an operating handle, the operating handle being configurable to drive the movable bearing housing to rotate, the fixed bearing housing and the movable bearing housing being provided with a first bearing set and a second bearing set which are fitted with the flexible shaft, respectively, where when the first bearing set is fitted with the flexible shaft, the flexible shaft is driven to advance, and when the second bearing set is fitted with the flexible shaft, the flexible shaft is driven to retract, whereby advance or retraction of the flexible shaft is controlled.

Since the existing drain cleaning machine needs to be provided with both of the flexible-shaft locking mechanism and the flexible-shaft telescoping control mechanism, its structure is complex, leading to a high manufacture cost and a bulky machine size; therefore, it is desirable in the art to simplify the structure of a drain cleaning machine and improve portability of the machine body.

### SUMMARY

To overcome at least the above drawbacks and deficiencies in conventional technologies, the disclosure provides a drain cleaning machine, in which forward/reverse rotation of an outer cylinder drives a slider to rotate a rotary member, thereby realizing locking or releasing of a flexible shaft; and thus the disclosure reasonably simplifies a locking structure while maintaining locking strength of the locking structure with respect to the flexible shaft.

To achieve the above technical objectives, the disclosure provides a drain cleaning machine, comprising a machine body in which a drive assembly is provided, a rotary drum driven by the drive assembly and having a flexible shaft wound therein, and a lead frame disposed in a front portion of the rotary drum and configurable to guide the flexible shaft to advance and retract, wherein the lead frame comprises an inner base, an outer cylinder rotatably sleeved outside the inner base, and locking structures operable to lock or release the flexible shaft; the flexible shaft passes through the inner base to project forwardly; each locking structure comprises a slider disposed on the inner base, a rotary member rotatably disposed on the slider, and an elastic member acting against the slider; the outer cylinder is provided with abutting sections each fitted with the slider; when the outer cylinder rotates forwardly about a central axis, the abutting section drives, via the slider, the rotary member to move towards the flexible shaft, and when the outer cylinder rotates reversely about the central axis, the abutting section releases the slider; the elastic member is configurable to be deformed when the slider drives the rotary member to move towards the flexible shaft, and configurable to drive, via the slider, the rotary member to move opposite the flexible shaft when the abutting section releases the slider.

In some implementations, the abutting section is an arc-shaped abutting surface provided on an inner wall of the outer cylinder and disposed eccentrically with respect to the central axis of the outer cylinder, distances between the arc-shaped abutting surface and the central axis of the outer cylinder increasing from one end to an opposite end.

In some implementations, an end of the arc-shaped abutting surface distant from the central axis of the outer cylinder smoothly engages an inner peripheral wall of the outer cylinder; and/or an end of the arc-shaped abutting surface proximal to the central axis of the outer cylinder is provided with a stop rib for limiting the slider.

In some implementations, the elastic member comprises a compression spring having one end abutting against the inner base and an opposite end abutting against the slider.

In some implementations, the inner base is provided with sliding grooves extending radially and each fitting with the slider, the slider being at least partially inserted in the sliding groove, the compressing spring having an end abutting against a groove wall of the sliding groove and an opposite end abutting against the slider.

In some implementations, the elastic members comprise an arc-shaped spring, and the slider is provided with an arc-shaped slot, the arc-shaped spring being partially located in the arc-shaped slot.

In some implementations, a head assembly is provided at a front end of the lead frame, the head assembly comprising a frame head secured at a front end of the inner base, a microswitch secured on the frame head, a movable sleeve movably connected to the frame head and operable to activate the microswitch, and a head spring disposed between the frame head and the movable sleeve; the flexible shaft is provided with a thickened section projecting out of the head assembly; the head spring is configurable to be deformed when the thickened section abuts against the movable sleeve to drive the movable sleeve to approach and activate the microswitch during retraction of the flexible shaft, and configurable to drive, when the thickened portion is disengaged from the movable sleeve, the movable sleeve away from the lead frame so that the movable sleeve releases the microswitch.

In some implementations, the head assembly is provided with a scraper disposed at an outer periphery of the flexible shaft for scraping the flexible shaft; and/or a front end of the outer cylinder is provided at an outer periphery of the frame head, a limiting structure for limiting a circumferential direction of the outer cylinder being provided between the outer cylinder and the frame head.

In some implementations, a plurality of sliders are provided at even intervals along a circumferential direction of the inner base, a rotary member being provided on each slider; and/or, the rotary member is a bearing.

In some implementations, the slider is provided with a mounting surface disposed inclinedly relative to an axial direction of the lead frame for mounting the rotary member, the rotary member being rotatably mounted on the mounting surface, an axial direction of the rotary member being vertical to the mounting surface.

With the above technical solutions adopted, the disclosure offers the following advantages:
1. In the drain cleaning machine provided by the disclosure, the lead frame is provided with locking structures operable to lock or release the flexible shaft. When the outer cylinder rotates forwardly, the abutting section drives, via the slider, the rotary member to move towards the flexible shaft with the elastic member being deformed, so that the rotary member may hold or lock the flexible shaft; the flexible shaft, when being held by the rotary member, may smoothly advance into a pipe or may retract into the rotary drum, which enhances movement stability of the flexible shaft. The flexible shaft, when being locked by the rotary member, may maintain structural stability during removing dirt in the pipe, without retracting upon encountering an obstruction, whereby the flexible shaft may smoothly unclog the pipe. When the abutting section releases the slider, the elastic member recovered from deformation drives, via the slider, the rotary member to move opposite the flexible shaft, whereby the rotary member releases the flexible shaft so that the flexible shaft may move smoothly. By reasonably setting the specific structures of the lead frame and the locking structures, the disclosure reasonably simplifies the structure of the lead frame, where the slider may drive the rotary member to move towards or away from the flexible shaft via forward/reverse rotation of the outer cylinder, which facilitates user operation. In addition, the locking structure offers a high locking strength with respect to the flexible shaft, which may better satisfy locking requirements on the flexible shaft, thereby improving user operation experience.
2. The abutting section preferably is an arc-shaped abutting surface eccentrically disposed with respect to the central axis of the outer cylinder; the arc-shaped abutting surface, when rotating with the outer cylinder, may smoothly abut against or release the slider, so that the slider may smoothly drive the rotary member to move towards or opposite the flexible shaft. By reasonably setting the specific structure of the abutting section, the structural requirement of driving, via the slider, the rotary member to lock or release the flexible shaft is satisfied.
3. The end of the arc-shaped abutting surface distant from the central axis of the outer cylinder smoothly engages the inner peripheral wall of the outer cylinder, so that the slider may shift to fit with the inner wall of the outer cylinder or the arc-shaped abutting surface when the outer cylinder is rotating, whereby the arc-shaped abutting surface can smoothly drive, via the slider, the rotary member to move towards the flexible shaft; in this way, the rotary member may effectively hold or lock the flexible shaft.

The stop rib is provided at the end of the arc-shaped abutting surface proximal to the central axis of the outer cylinder, which may prevent the slider from disengaging from the arc-shaped abutting surface due to an overly large motion amplitude, thereby ensuring fitting stability between the slider and the arc-shaped abutting surface.
4. The elastic member comprises a compression spring; when the slider drives the rotary member to move towards the flexible shaft, the compression spring is compressed. When the abutting section releases the slider, the compression spring recovered from compression drives the slider to move opposite the flexible shaft, and the slider drives the rotary member to move synchronously so that the rotary member releases the flexible shaft. By reasonably setting the specific structure of the elastic member, the requirement of driving, via the slider, the rotary member to move opposite the flexible shaft to release the flexible shaft is satisfied.
5. The slider is partially inserted in the sliding groove of the inner base; the sliding groove may play a role of limiting movement of the slider, so that the slider can only move along an extended direction of the sliding groove, thereby improving stability when the slider drives the rotary member to move towards or opposite the flexible shaft; in this way, locking stability of the locking structure with respect to the flexible shaft may be improved.
6. The elastic member comprises an arc-shaped spring, the arc-shaped spring being partially inserted in the arc-shaped slot of the slider; when the slider is driven by the abutting action of the abutting section to bring the rotary member to move towards the flexible shaft, the arc-shaped spring is deformed. When the abutting section releases the slider, the arc-shaped spring recovered from deformation drives the slider to move opposite the flexible shaft, and the slider drives the rotary member to move synchronously causing the rotary member to release the flexible shaft. By reasonably setting the specific structure of the elastic member, the requirement of driving, via the slider, the rotary member to move opposite the flexible shaft to release the flexible shaft is satisfied.
7. The head assembly is provided at the front end of the lead frame; after the flexible shaft retracts till the thickened section abuts against the movable sleeve, the continuously retracting thickened section drives the movable sleeve to move backward to approach the lead frame, while the backwardly moving movable sleeve applies a force against the head spring, causing the latter to be deformed. When the movable sleeve triggers the microswitch, the movable sleeve moves backwards in place, indicating that the flexible shaft retracts in place; then, the drive assembly stops operation so that the flexible shaft stops retraction, thereby preventing structural deformation due to over-retraction of the flexible shaft. When the flexible shaft moves forward so that the thickened section releases the movable sleeve, the head spring recovered from deformation drives the movable sleeve to move forward away from the lead frame, whereby the movable sleeve releases the microswitch. By reasonably setting the specific structure of the head assembly, it may generate an in-place signal promptly when the flexible shaft retracts in place, so that the drive assembly may promptly stops driving.
8. The scraper is provided at the outer periphery of the flexible shaft; during retraction of the flexible shaft, the scraper scrapes the flexible shaft, so that dirt carried by the flexible shaft may be removed, which improves cleanness of the flexible shaft during retraction into the rotary drum and prevents the dirt from entering the rotary drum along with the flexible shaft, thereby preventing odors or mildews generated in the rotary drum; in this way, the cleanness of the machine is improved, and use experience of users is enhanced.

The limiting structure is disposed between the outer cylinder and the frame head. The outer cylinder is peripherally limited by the limiting structure, preventing the arc-shaped abutting surface from releasing the slider caused by retraction of the outer cylinder when the locking structure holds the flexible shaft tightly, which facilitates enhancing locking stability of the locking structure with respect to the flexible shaft.
9. A plurality of sliders are arranged at even intervals along the circumferential direction of the inner base, and a rotary member is provided on each slider. By reasonably setting the specific structure of the locking structure, the locking strength and locking stability of the locking structure with respect to the flexible shaft are enhanced. The rotary member may adopt a bearing. By reasonably setting the specific structure of the rotary member, the locking structure is reasonably simplified.
10. The rotary member is rotatably disposed on the mounting surface of the slider, the axial direction of the rotary member being vertical to the mounting surface; since the mounting surface on the slider is inclinedly set relative to the axial direction of the lead frame, the axial direction of the rotary member is also set inclinedly relative to the axial direction of the lead frame. By reasonably setting the mounting structure of the rotary member, the rotary member may effectively lock or release the flexible shaft.

### BRIEF DESCRIPTION OF THE DRAWINGS

FIG. 1 is an overall structural diagram of a drain cleaning machine according to a first embodiment of the disclosure;

FIG. 2 is an exploded view of the overall structure of the drain cleaning machine according to the first embodiment of the disclosure;

FIG. 3 is a local structural diagram of a main body of the drain cleaning machine according to the first embodiment of the disclosure;

FIG. 4 is a local structural diagram of the drain cleaning machine according to the first embodiment of the disclosure;

FIG. 5 is an exploded view of a lead frame in the drain cleaning machine according to the first embodiment of the disclosure;

FIG. 6 is a sectional view in which a partial structure of the lead frame in the drain cleaning machine is vertical to an axial direction according to the first embodiment of the disclosure;

FIG. 7 is a structural schematic diagram illustrating a slider, a rotary member, and a compression spring in the drain cleaning machine according to the first embodiment of the disclosure;

FIG. 8 is a structural schematic diagram of the slider in the drain cleaning machine according to the first embodiment of the disclosure;

FIG. 9 is a structural schematic diagram of an inner base in the drain cleaning machine according to the first embodiment of the disclosure;

FIG. 10 is a structural schematic diagram of an outer cylinder in the drain cleaning machine according to the first embodiment of the disclosure;

FIG. 11 is a side view of an end portion of the outer cylinder in the drain cleaning machine according to the first embodiment of the disclosure;

FIG. 12 is an exploded view of a head assembly in the drain cleaning machine according to the first embodiment of the disclosure;

FIG. 13 is a structural schematic diagram of fitting between the head assembly and the lead frame in the drain cleaning machine according to the first embodiment of the disclosure;

FIG. 14 is a local structural schematic diagram of a front end of the outer cylinder in the drain cleaning machine according to the first embodiment of the disclosure;

FIG. 15 is a structural schematic diagram of fitting between the head assembly and the lead frame in a drain cleaning machine according to a second embodiment of the disclosure.

In the drawings, 100—main body; 110—casing; 101—grip portion; 200—drive assembly; 210—electric motor; 220—reducer; 230—coupling; 231—supporting sleeve; 232—coupling shaft; 300—rotary drum; 310—front cap; 320—back plate; 330—port; 400—flexible shaft; 410—thickened section; 500—lead frame; 510—inner base; 511—securing portion; 512—sliding groove; 513—notch; 520—outer cylinder; 521—flared section; 522—arc-shaped abutting surface; 522a—proximal end; 522b—distal end; 523—stop rib; 524—restraint slot; 524a—first slot segment; 524b—second slot segment; 530—locking structure; 531—slider; 5311—boss portion; 5312—mounting surface; 5313—mounting hole; 5314—recessed groove; 5315—locating column; 5316—arc-shaped slot; 5317—cylindrical part; 532—rotary member; 540—inner sleeve; 541—through hole; 551—compression spring; 552—arc-shaped spring; 600—housing; 610—front housing body; 611—central hole; 620—rear housing body; 700—head assembly; 710—frame head; 711—recessed hole; 720—microswitch; 730—movable sleeve; 740—head spring; 750—shoulder screw; 760—metallic tongue piece; 771—column sleeve; 772—limit roller; 773—limit spring; 780—scraper.

### DETAILED DESCRIPTION OF EMBODIMENTS

Hereinafter, the disclosure will be further described through specific embodiments with reference to the accompanying drawings. It is appreciated that the terms “upper”, “lower”, “left”, “right”, “longitudinal”, “transverse”, “inner”, “outer”, “vertical”, “horizontal”, “top” and “bottom” herein to indicate orientational or positional relationships only refer to the orientational or positional relationships illustrated in the accompanying drawings, which only intend for describing the disclosure and simplifying the description, not indicating or implying that the devices/components referred to herein must have the indicated orientations or must be constructed and operated with the specific orientations, so that they cannot be construed as limitations to the disclosure.

### First Embodiment

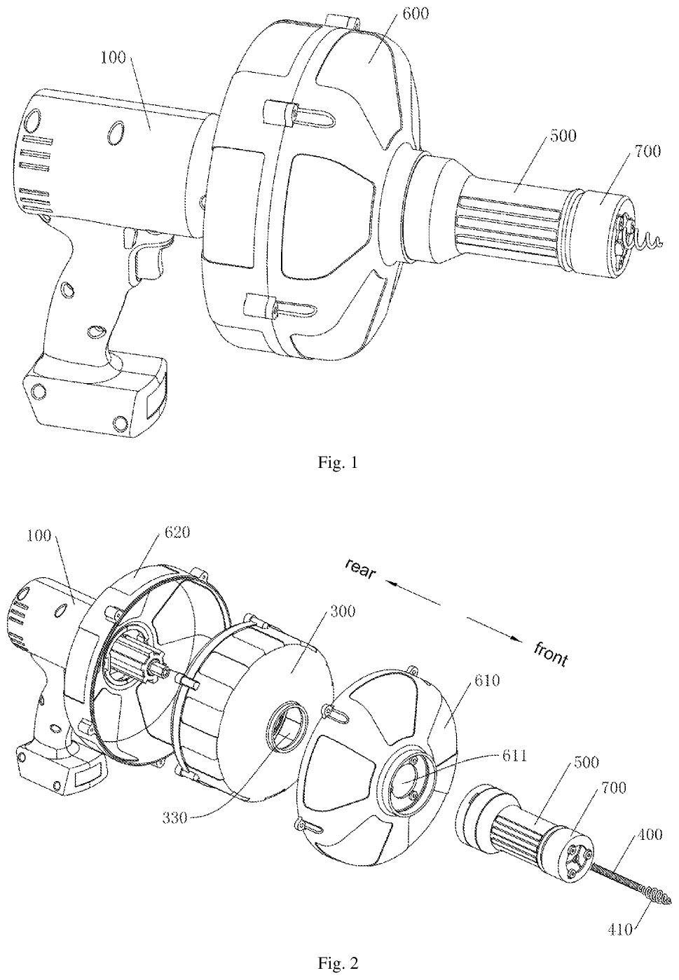

Referring to FIGS. 1 to 14, in a first embodiment of the disclosure, there is provided a drain cleaning machine, comprising: a main body 100 in which a drive assembly 200 is provided, a rotary drum 300 driven by the drive assembly 200 and having a flexible shaft 400 wound therein, and a lead frame 500 disposed in front of the rotary drum 300 and configurable to guide the flexible shaft 400 to advance and retract; the lead frame 500 comprises an inner base 510, an outer cylinder 520 rotatably sleeved outside the inner base 510, and locking structures 530 operable to lock or release the flexible shaft 400; the flexible shaft 400 passes through the inner base 510 to project outwardly; the locking structure 530 comprises a slider 531 disposed on the inner base 510, a rotary member 532 rotatably disposed on the slider 531, and an elastic member acting against the slider 531; and the outer cylinder 520 is provided with abutting sections fitted with the sliders 531. The outer cylinder 520 rotates forwardly about a central axis so that the abutting section drives, via the slider 531, the rotary member 532 to move towards the flexible shaft 400; and the outer cylinder 520 rotates reversely about the central axis so that the abutting section releases the slider 531. The elastic member is configurable to be deformed when the slider 531 drives the rotary member 532 to move towards the flexible shaft 400, and configurable to drive, via the slider 531, the rotary member 532 to move opposite the flexible shaft 400 when the abutting section releases the slider 531.

When the outer cylinder rotates forwardly, the abutting section drives, via the slider, the rotary member to move towards the flexible shaft with the elastic member being deformed, so that the rotary member may hold or lock the flexible shaft; the flexible shaft, when being held by the rotary member, may smoothly advance into a pipe or may retract into the rotary drum, which enhances movement stability of the flexible shaft. The flexible shaft, when being locked by the rotary member, may maintain structural stability during removing dirt in the pipe, without retracting upon encountering an obstruction, whereby the flexible shaft may smoothly unclog the pipe. When the abutting section releases the slider, the elastic member recovered from deformation drives, via the slider, the rotary member to move opposite the flexible shaft, whereby the rotary member releases the flexible shaft so that the flexible shaft may move smoothly. By reasonably setting the specific structures of the lead frame and the locking structures, the disclosure reasonably simplifies the structure of the lead frame, where the slider may drive the rotary member to move towards or away from the flexible shaft via forward/reverse rotation of the outer cylinder, which facilitates user operation. In addition, the locking structure offers a high locking strength with respect to the flexible shaft, which may better satisfy locking requirements on the flexible shaft, thereby improving user operation experience.

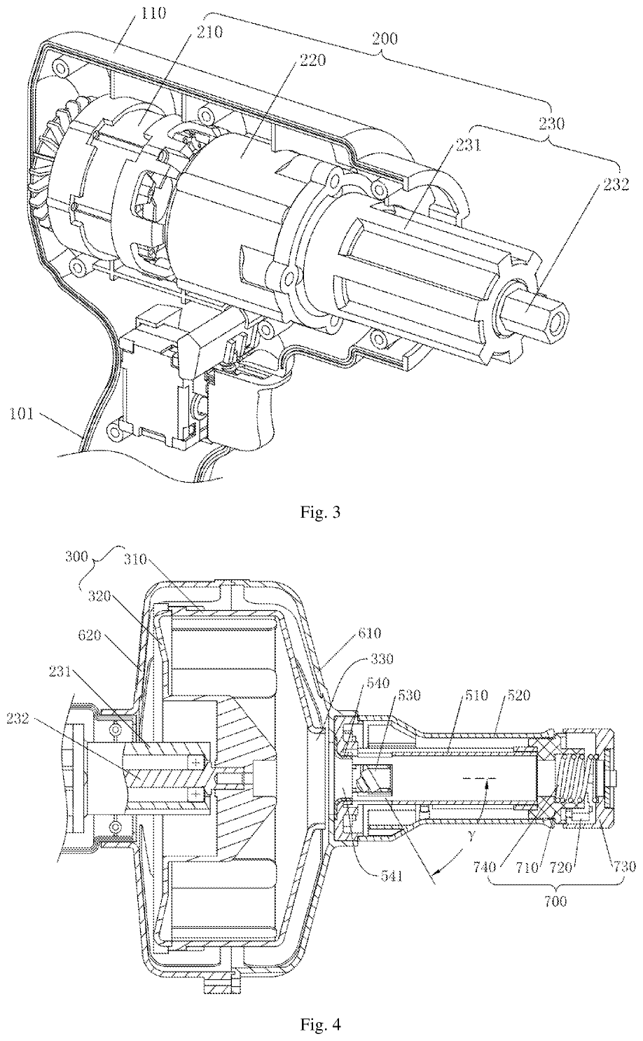

Referring to FIG. 3, in this embodiment, the main body 100 comprises a casing 110, the casing 110 being formed with a grip portion 101; the drive assembly 200 comprises an electric motor 210, a reducer 220, and a coupling 230 which are arranged sequentially from aft to fore; the coupling 230 comprises a supporting sleeve 231 fixed at a front end of the casing 110 and a coupling shaft 232 rotatably provided in the supporting sleeve 231, a rear end of the coupling shaft 232 being in transmission connection with an output shaft of the reducer 220, a front end of the coupling shaft 232 projecting out of the supporting sleeve 231 and being in transmission fit with the rotary drum 300.

Referring to FIG. 2, the drain cleaning machine further comprises a housing 600 mounted at a front end of the main body 100; the housing 600 comprises a front housing body 610 and a rear housing body 620 which are fixed together, the rear housing body 620 being sleeved outside the front end of the main body 100, the lead frame 500 being disposed on the front side of the front housing body 610, the rotary drum 300 being rotatably disposed in the housing 600. The rotary drum 300 comprises a front cap 310 and a rear plate 320 which are fixed together to form an inner cavity, a port 330 through which the flexible shaft 400 advances and retracts being formed in the center of the front cap 310, a central hole 611 for the flexible shaft 400 to pass through being formed in the center of the front housing body 610, and a transmission hole for a front end of the coupling shaft 232 to insert being formed in the center of the rear plate 320; the front end of the coupling shaft 232 and the transmission hole adopt a hexagonal shaft-hole fitting structure, so that the rotating coupling shaft 232 is fitted with the transmission hole to drive the rotary drum 300 to rotate synchronously. It may be understood that the front end of the coupling shaft 232 and the transmission hole in the center of the rear plate 320 may also adopt other non-round shaft-hole fitting structures such as a rectangular shaft-hole fitting structure, an oblate shaft-hole fitting structure, and a spline shaft-hole fitting structure to realize transmission fit.

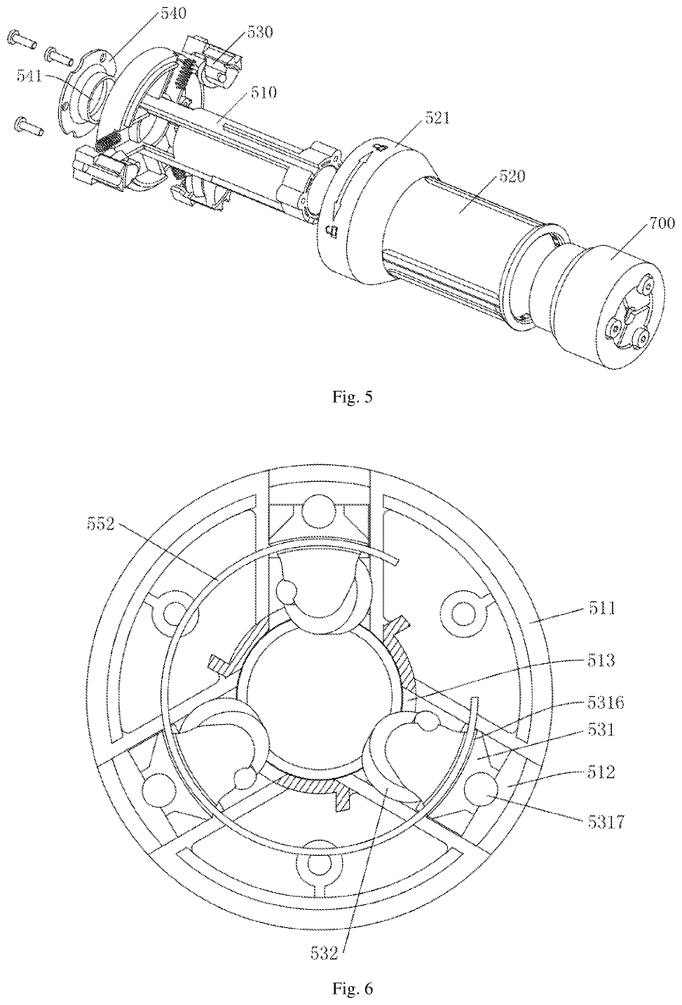

Referring to FIGS. 4 and 5, the flexible shaft 400 adopts a spring steel wire, the inner base 510 is hollow, and the lead frame 500 further comprises a metallic inner sleeve 540, the inner sleeve 540 being secured to a rear end of the inner base 510 and having a through hole 541 for the flexible shaft 400 to pass through; the metallic inner sleeve 540 mitigates wear to the inner base 510 caused by advance and retraction of the flexible shaft 400.

Referring to FIG. 6, in this embodiment, a plurality of sliders 531 are arranged at even intervals along a circumferential direction of the inner base 510, each slider 531 having a rotary member 532 provided thereon. Referring to FIG. 9, the rear end of the inner base 510 is provided with a securing portion 511 that is docking-fitted with the front housing body 610, a front side of the securing portion 511 being provided with three sliding grooves 512 that are circumferentially arranged at even intervals and extend along different radial directions, a rear end of each slider 531 being inserted in the corresponding sliding groove 512. The sliding grooves 512 play a role of limiting the moving sliders 531, so that the sliders 531, when being driven, can only move along the sliding grooves 512, which enhances stability when the sliders 531 drive the rotary members 532 to move towards or opposite the flexible shaft 400.

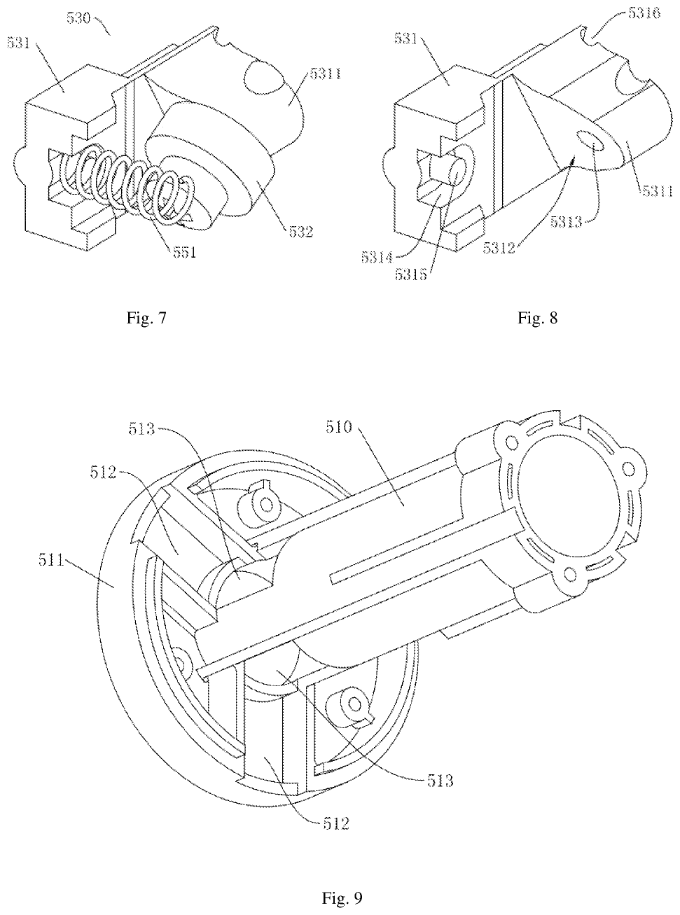

Referring to FIGS. 7 and 8, the slider 531 is provided with a boss portion 5311 projecting towards the axial center of the lead frame 500, the boss portion 5311 being configurable to mount the rotary member 532, a mounting surface 5312 disposed inclinedly relative to an axial direction of the lead frame 500 being provided on a front side or a rear side of the boss portion 5311, the rotary member 532 being rotatably disposed on the mounting surface 5312, the axial direction of the rotary member 532 being disposed vertical to the mounting surface 5312. In this embodiment, the rotary member 532 may preferably adopt a metallic bearing, the bearing being rotatably mounted on the mounting surface 5312 via a screw; a mounting hole 5313 fitted with the screw being formed on the boss portion 5311, the axial direction of the mounting hole 5313 being arranged vertical to the mounting surface 5312; a rear end of the inner base 510 is provided with a notch 513 for avoiding the rotary member 532, via which notch 513 the rotary member 532 may project into the inner base 510 to hold the flexible shaft 400. It may be understood that an inclined angle γ of the mounting surface 5312 relative to the axial direction of the lead frame 500 may be reasonably set to 40°, 45°, 50°, 55°, 60°, 65°, and 70°, which is not limited herein.

Referring to FIGS. 6 and 7, the elastic members comprise compression springs 551 and an arc-shaped spring 552, an end of each compression spring 551 abutting against the inner base 510, an opposite end thereof abutting against the corresponding slider 531, the arc-shaped spring 552 being arranged at respective front ends of the sliders 531 so as to fit with all of the sliders 531. In this embodiment, a compression spring 551 is provided on a side of the corresponding slider 531 facing the axial center of the lead frame 500, the compression springs 551 being disposed in one-to-one correspondence with the sliders 531; a recessed groove 5314 is provided on a side of the slider 531 facing the axial center of the lead frame 500, a locating column 5315 projecting towards the axial center of the lead frame 500 being provided in the recessed groove 5314; an end of each compression spring 551 abuts against a groove wall on a side of the corresponding sliding groove 512 facing the axial center of the lead frame 500 so as to abut against the inner base 510, and an opposite end of the compression spring 551 is sleeved on the locating column 5315 and abuts against the corresponding slider 531. An arc-shaped slot 5316 is formed on a front surface of each slider 531, with an arc-shaped segment of the arc-shaped spring 552 corresponding to each slider 531 being disposed in the arc-shaped slot 5316 of the slider 531. When respective sliders 531 drive the rotary members 532 to move towards the flexible shaft 400, the compression springs 551 and the arc-shaped spring 552 are all deformed. When the abutting sections release the sliders 531, the compression springs 551 and arc-shaped spring 552 recovered from deformation drive the sliders 531 to move opposite the flexible shaft 400, thereby driving the rotary members 532 to move away from the flexible shaft 400. It may be understood that, the arc-shaped slot 5316 fitting with the arc-shaped spring 552 on each slider 531 may also be disposed at another location of the slider 531, e.g., on a surface of the slider 531 facing the axial center of the lead frame 500, which is not limited herein, and it is only required to satisfy the requirement of fitting with the arc-shaped spring 552 to drive the slider 531 to reset. In addition, if the compression spring 551 satisfies the requirement of driving the slider 531 to reset, the arc-shaped spring 552 may also be eliminated, i.e., the elastic member only comprises the compression spring 551.

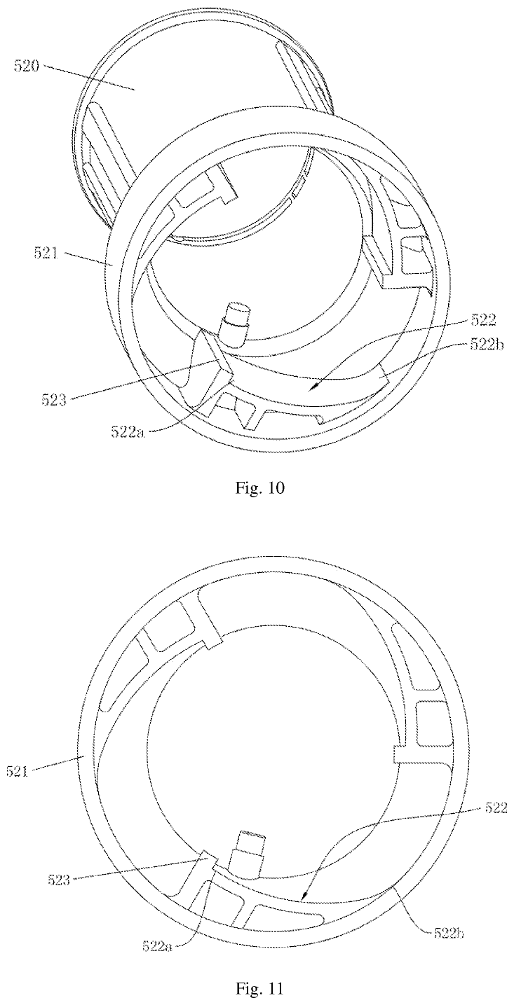

Referring to FIGS. 10 and 11, in this embodiment, the abutting section is an arc-shaped abutting surface 522 provided on an inner wall of the outer cylinder 520 and disposed eccentrically with respect to the central axis of the outer cylinder 520, distances between the arc-shaped abutting surface 522 and the central axis of the outer cylinder 520 increasing from one end to the opposite end. Specifically, a rear end of the outer cylinder 520 is provided with a flared section 521 fitted with the securing portion 511, the arc-shaped abutting surfaces 522 being provided on an inner wall of the flared section 521, the arc-shaped abutting surfaces 522 being arranged in one-to-one correspondence with the sliders 531 and disposed at even intervals along the circumferential direction of the flared section 521. The arc-shaped abutting surface 522 has a distal end 522b distant from the central axis of the outer cylinder 520 and a proximal end 522a proximal to the central axis of the outer cylinder 520; the distal end 522b of the arc-shaped abutting surface 522 smoothly engaging an inner peripheral wall of the flared section 521 so that when the outer cylinder 520 rotates, the corresponding slider 531 can smoothly fit with the arc-shaped abutting surface 522. To prevent the slider 531 from being disengaged from the corresponding arc-shaped surface 522, the proximal end 522a of the arc-shaped abutting surface 522 is provided with a stop rib 523 projecting towards the axial center of the outer cylinder 520.

To reduce friction between the slider 531 and the corresponding arc-shaped abutting surface 522, a cylindrical part 5317 fitted with the arc-shaped abutting surface 522 is provided on a side of the slider 531 facing the arc-shaped abutting surface 522, the cylindrical part 5317 being in abutting-fit with the arc-shaped abutting surface 522. When the outer cylinder 520 rotates forwardly to drive the sliders 531 to move relative to the arc-shaped abutting surfaces 522 till abutting against the corresponding stop ribs 523, the sliders 531 drive the rotary members 532 to move towards the flexible shaft 400 in place, where the rotary members 532 are nearest to the flexible shaft 400; now, the respective rotary members 532 cooperate to hold the flexible shaft 400 tightly, so that the flexible shaft 400 cannot advance or retract.

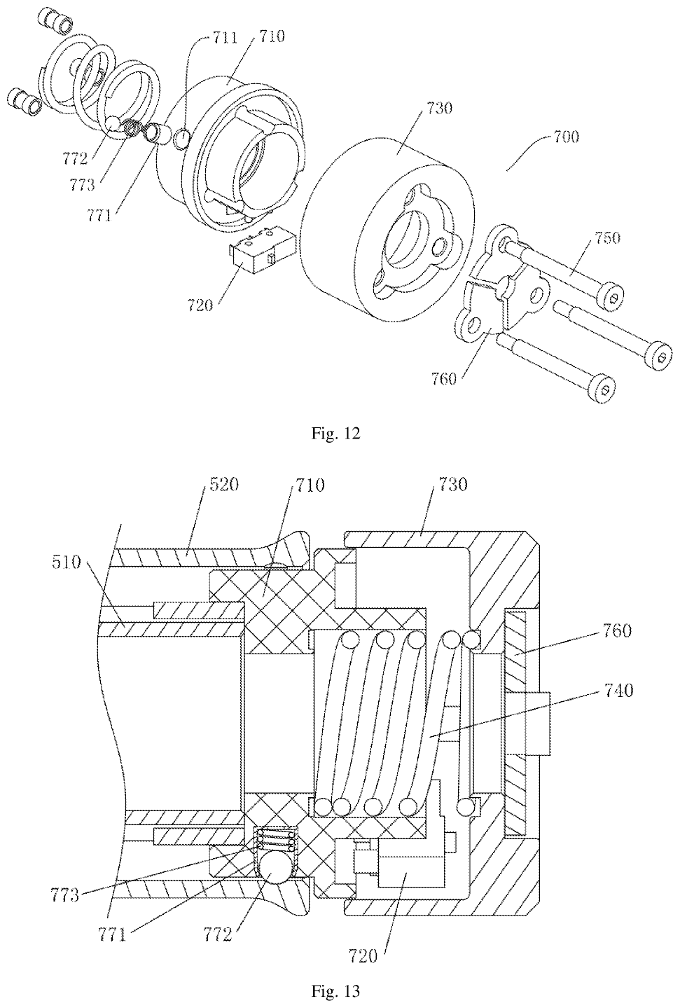

Referring to FIGS. 12 and 13, a front end of the lead frame 500 is provided with a head assembly 700, the head assembly 700 comprising a frame head 710 secured at a front end of the inner base 510, a microswitch 720 secured on the frame head 710, a movable sleeve 730 movably connected to the frame head 710 and operable to activate the microswitch 720, and a head spring 740 disposed between the frame head 710 and the movable sleeve; the flexible shaft 400 passes through the head assembly 700 and is provided with a thickened section 410 projecting out of the head assembly 700; the movable sleeve 730 and the frame head 710 are disposed at the front end of the inner base 510 via a shoulder screw 750; the frame head 710 is secured to the front end of the inner base 510; the movable sleeve 730 is fore-and-aft movably disposed at the front end of the inner base 510; the head spring 740 is disposed outside the flexible shaft 400; a rear end of the head spring 740 abuts against a stepped surface on the inner wall of the frame head 710 so as to be positioned; a front end of the head spring 740 abuts against the movable sleeve 730. In this embodiment, the microswitch 720 is connected to a control module of the machine body. After the flexible shaft 400 retracts till the thickened section 410 to abut against the movable sleeve 730, the continuously retracting thickened section 410 drives the movable sleeve 730 to move backward to approach the lead frame 500, while the backwardly moving movable sleeve 730 applies a force against the head spring 740, causing the latter to be deformed. When the movable sleeve 730 triggers the microswitch 720, the movable sleeve 730 moves backwards in place, indicating that the flexible shaft 400 retracts in place; the control module, in response to a trigger signal from the microswitch 720, instructs the drive assembly 200 to stop operation so that the flexible shaft 400 stops retraction, thereby preventing structural deformation due to over-retraction of the flexible shaft 400. When the flexible shaft 400 moves forward so that the thickened section 410 releases the movable sleeve 730, the head spring 740 recovered from deformation drives the movable sleeve 730 to move forward away from the lead frame 500, whereby the movable sleeve 730 releases the microswitch 720. It may be understood that, the microswitch 740 may be fixed external to the frame head 710, and a button may be set on a front side of the microswitch 740, so that when the movable sleeve 730 moving backward in place presses the button, the microswitch is activated. Of course, the activation manner of the microswitch 740 is not limited thereto, and other appropriate activation manners are also allowed.

To prevent the movable sleeve 730 from being seriously worn due to direct contact between the metallic flexible shaft 400 and the movable sleeve 730, a plurality of metallic tongue pieces 760 arranged circumferentially at intervals are secured on the movable sleeve 730; the metallic tongue pieces 760 being combined to form a hole for the flexible shaft 400 to pass through, an inner diameter of the hole being smaller than an outer diameter of the thickened section 410, where the flexible shaft 400 passes through the hole formed by the metallic tongue pieces 760. When the flexible shaft 400 retracts, the thickened section 410 abuts against the metallic tongue pieces 760 to drive the movable sleeve 730 to move backward, whereby the microswitch 720 is activated.

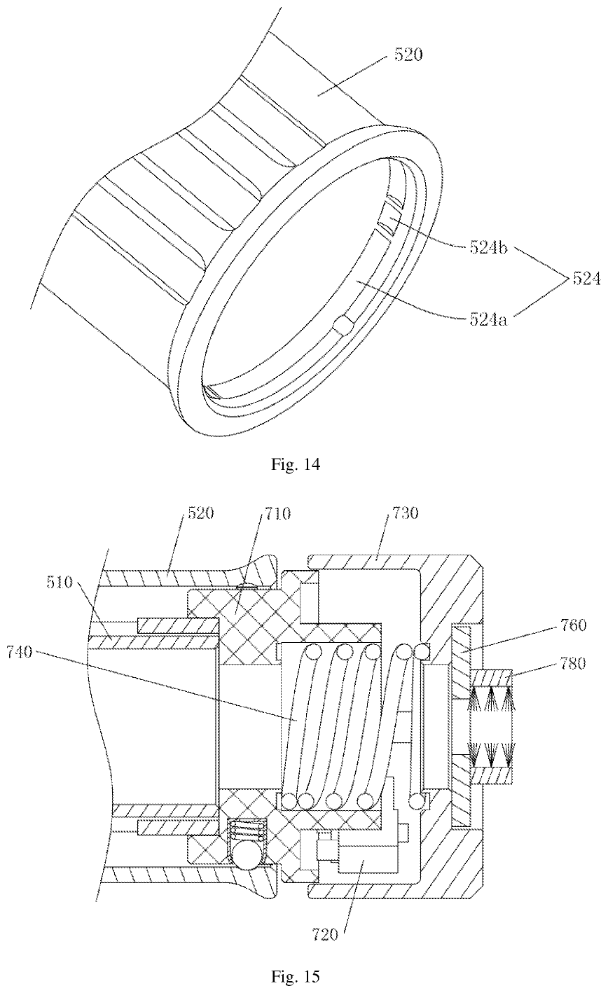

A rear portion of the frame head 710 is sleeved outside the front end of the inner base 510, and the front end of the outer cylinder 520 is sleeved outside the rear portion of the frame head 710. To enable the arc-shaped abutting surfaces 522 and the sliders 531 to maintain a stable fitted state when the rotary members 532 hold the flexible shaft 400 tightly, the outer cylinder 520 needs to maintain stable circumferentially. To this end, a limiting structure for limiting the circumferential direction of the outer cylinder 520 is provided between the outer cylinder 520 and the frame head 710. Referring to FIGS. 12 and 13, in this embodiment, a recessed hole 711 extending along a certain radial direction is formed on a circumferential outer wall of the frame head 710, a column sleeve 771 being provided in the recessed hole 711; a limit roller 772 and a limit spring 773 are provided in the column sleeve 771; the limit roller 772 is partially exposed out of the column sleeve 771; an end of the limit spring 773 abuts against an inner wall of the column sleeve 771 so as to be positioned, and an opposite end of the limit spring 773 abuts against the limit roller 772. Referring to FIG. 14, a restraint slot 524 fitted with the limit roller 772 is provided on an inner wall of the front end of the outer cylinder 520, the restraint slot 524 comprising a first slot segment 524a and a second slot segment 524b which are arranged circumferentially at an interval, where the first slot segment 524a has a large radian, while the second slot segment 524b has a smaller radian. When the sliders 531 drive the rotary members 532 to move towards the flexible shaft 400 causing the rotary members 532 to hold the flexible shaft 400 tightly, the fitting between the limit roller 772 and the second slot segment 524b results in circumferential limit of the outer cylinder 520, preventing circumferential rotation of the outer cylinder 520, whereby the arc-shaped abutting surfaces 522 do not release the sliders 531 so that the rotary members 532 are not be driven by the elastic force of the elastic members to move opposite the flexible shaft 400 and to thereby release the flexible shaft 400.

When the machine operates, the drive assembly 200 drives the rotary drum 300 forwardly to rotate about its central axis, rotation of the rotary drum 300 driving the flexible shaft 400 wound therein to advance; now, the rotary members 532 hold the flexible shaft 400, but loosely, so that the rotary members 532 may rotate when the flexible shaft 400 is advancing.

After the flexible shaft 400 advances to an appropriate length, the user applies a force against the outer cylinder 520 to cause it to rotate forwardly about its central axis, so that the sliders 531 move relative to the arc-shaped abutting surfaces 522 from the distal ends 522b to the proximal ends 522a, causing the sliders 531 to drive the rotary members 532 to move towards the flexible shaft 400, the outer cylinder 520 rotating in place when the limit roller 772 is fitted with the second slot segment 524b; now, the rotary members 532 hold the flexible shaft 400 tightly, so that the flexible shaft 400 cannot advance or retract.

After the unclogging operation is completed and the flexible shaft 400 is to retract, the user applies a force against the outer cylinder 520 to cause it to rotate reversely about its central axis, so that the sliders 531 move relative to the arc-shaped abutting surfaces 522 from the proximal ends 522a to the distal ends 522b, causing the arc-shaped abutting surfaces 522 to release the sliders 531; the compression springs 551 and the arc-shaped spring 552 recovered from deformation drive the sliders 531 to move opposite the flexible shaft 400, so that the sliders 531 drive the rotary members 532 away from the flexible shaft 400, whereby the rotary members 532 release the flexible shaft 400; now, the limit roller 772 shifts to fit with the first slot segment 524a.

Then, the drive assembly 200 is activated to drive the rotary drum 300 reversely to rotate about its central axis; rotation of the rotary drum 300 drives the flexible shaft 400 to retract and be rewound in the rotary drum 300; during retraction of the flexible shaft 400, the rotary members 532 hold the flexible shaft 400, but loosely, so that the rotary members 532 may rotate when the flexible shaft 400 is retracting. After the flexible shaft 400 retracts till the thickened section 410 engages the metallic tongue pieces 760, the continuously retracting thickened section 410 drives the movable sleeve 730 to move backward to approach the lead frame 500; the backwardly moving movable sleeve 730 applies a force against the head spring 740, causing the head spring 740 to be deformed. When the movable sleeve 730 activates the microswitch 720, the movable sleeve 730 moves backward in place, indicating that the flexible shaft 400 retracts in place, whereby the drive assembly 200 is deactivated and the flexible shaft 400 stops retraction.

It may be understood that, the microswitch 740 may also adopt a magnetic switch; in this case, a magnet for activating the magnetic switch may be provided on the movable sleeve 730.

### Second Embodiment

Referring to FIG. 15, to prevent dirt from entering the rotary drum 300 along with the flexible shaft 400, the head assembly 700 is provided with a scraper 780 which is disposed at an outer periphery of the flexible shaft 400 for scraping the flexible shaft 400. In this embodiment, the scraper 780 is disposed on a front side of each metallic tongue piece 760. The scraper 780 is of a ring shape; bristles in contact with the flexible shaft 400 are provided on an inner peripheral wall of the scraper 780; when the flexible shaft 400 is retracting, the bristles brush the flexible shaft 400 to remove dirt carried by the flexible shaft 400; this improves cleanness of the flexible shaft 400 when retracting into the rotary drum 300, thereby preventing odors or mildews generated in the rotary drum 300.

Of course, the specific structure of the scraper 780 is not limited to the above description or the illustrations in the drawings. For example, the scraper 780 may also adopt an elastic scraping sleeve, the scraping sleeve being fixed in the head assembly and disposed at an outer periphery of the flexible shaft 400, a plurality of scraping ribs axially distributed in contact with the flexible shaft 400 being provided on an inner peripheral wall of the scraping sleeve; when the flexible shaft 400 is retracting, the scraping ribs scraping the flexible shaft 400 to remove the dirt carried by the flexible shaft 400.

The remaining structures of the second embodiment are identical to those of the first embodiment, which are not detailed here.

Besides the preferable embodiments described above, the disclosure further has other embodiments; various changes and transformations made by those skilled in the art based on the disclosure shall fall within the scope defined in the appended claims without departing from the spirits of the disclosure.

I/We claim:

1. A drain cleaning machine, comprising a machine body in which a drive assembly is provided, a rotary drum driven by the drive assembly and having a flexible shaft wound therein, and a lead frame disposed in a front portion of the rotary drum and configurable to guide the flexible shaft to advance and retract, wherein the lead frame comprises an inner base, an outer cylinder rotatably sleeved outside the inner base, and locking structures operable to lock or release the flexible shaft; the flexible shaft passes through the inner base to project forwardly; the locking structure comprises a slider disposed on the inner base, a rotary member rotatably disposed on the slider, and an elastic member acting against the slider; the outer cylinder is provided with abutting sections each fitted with the slider; when the outer cylinder rotates forwardly about a central axis, the abutting section drives, via the slider, the rotary member to move towards the flexible shaft, and when the outer cylinder rotates reversely about the central axis, the abutting section releases the slider; the elastic member is configurable to be deformed when the slider drives the rotary member to move towards the flexible shaft, and configurable to drive, via the slider, the rotary member to move opposite the flexible shaft when the abutting section releases the slider.

2. The drain cleaning machine according to claim 1, wherein the abutting section is an arc-shaped abutting surface provided on an inner wall of the outer cylinder and disposed eccentrically with respect to the central axis of the outer cylinder, distances between the arc-shaped abutting surface and the central axis of the outer cylinder increasing from one end to an opposite end.

3. The drain cleaning machine according to claim 2, wherein an end of the arc-shaped abutting surface distant from the central axis of the outer cylinder smoothly engages an inner peripheral wall of the outer cylinder; and/or an end of the arc-shaped abutting surface proximal to the central axis of the outer cylinder is provided with a stop rib for limiting the slider.

4. The drain cleaning machine according to claim 1, wherein the elastic member comprises a compression spring having one end abutting against the inner base and an opposite end abutting against the slider.

5. The drain cleaning machine according to claim 4, wherein the inner base is provided with sliding grooves extending radially and each fitting with the slider, the slider being at least partially inserted in the corresponding sliding groove, the compression spring having an end abutting against a groove wall of the sliding groove and an opposite end abutting against the slider.

6. The drain cleaning machine according to claim 4, wherein the elastic members comprise an arc-shaped spring, and the slider is provided with an arc-shaped slot, the arc-shaped spring being partially located in the arc-shaped slot.

7. The drain cleaning machine according to claim 1, wherein a head assembly is provided at a front end of the lead frame, the head assembly comprising a frame head secured at a front end of the inner base, a microswitch secured on the frame head, a movable sleeve movably connected to the frame head and operable to activate the microswitch, and a head spring disposed between the frame head and the movable sleeve; the flexible shaft is provided with a thickened section projecting out of the head assembly; the head spring is configurable to be deformed when the thickened section abuts against the movable sleeve to drive the movable sleeve to approach and activate the microswitch during retraction of the flexible shaft, and configurable to drive, when the thickened portion is disengaged from the movable sleeve, the movable sleeve away from the lead frame so that the movable sleeve releases the microswitch.

8. The drain cleaning machine according to claim 7, wherein the head assembly is provided with a scraper disposed at an outer periphery of the flexible shaft for scraping the flexible shaft; and/or a front end of the outer cylinder is provided at an outer periphery of the frame head, a limiting structure for limiting a circumferential direction of the outer cylinder being provided between the outer cylinder and the frame head.

9. The drain cleaning machine according to claim 1, wherein a plurality of sliders are provided at even intervals along a circumferential direction of the inner base, a rotary member being provided on each slider; and/or, the rotary member is a bearing.

10. The drain cleaning machine according to claim 1, wherein the slider is provided with a mounting surface disposed inclinedly relative to an axial direction of the lead frame for mounting the rotary member, the rotary member being rotatably mounted on the mounting surface, an axial direction of the rotary member being vertical to the mounting surface.
